(19) United States
(12) Patent Application Publication
(10) Pub. No.: US 2009/0046884 A1
(43) Pub. Date: Feb. 19, 2009

(54) HEADSET MADE FROM RECYCLABLE ISOLATING MATERIALS

(76) Inventor: Eduardo SCHAPIRO, Hadera (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/838,957

(22) Filed: Aug. 15, 2007

(51) Int. Cl. H04R 25/00

(52) U.S. Cl. 381/374

(57) ABSTRACT

Headset made from recyclable, disposable and isolating materials such as, for example, paper, cardboard and the like. The headset may comprise ear-members integrated with ear-fasteners and an oblong connecting strip made from isolating materials that may be connected to an ear-member at each end. The ear-members and the connecting-strip may hold at least one speaker connected by conductive-means to an audio player, where each speaker may be seated substantially at the central area of each ear-member. The ear-fasteners may fasten the headset to a user's ear-auricle to enable holding the entire headset over the user's head.

### FIELD OF THE INVENTION

The present invention relates generally to the field of headsets. More particularly, the present invention relates to environment-friendly headsets.

### BACKGROUND OF THE INVENTION

Mass distributed earphones and other types of headsets have become very popular in recent years, in a variety of places and services such as flights, internet cafés etc. Presently, these headsets are distributed freely to customers and are collected subsequently after use to be reused by following customers and users. The collected headsets are cleaned, refurbished, repacked and redistributed to the new customers.

A headset may be any device designed to fit around a user's head that is integrated with audio devices. For example, the headset may be a set of earphones, a microphone that attaches to the user's head in order to be held adjacent to the user's mouth, or both. Headset may be connected to audio systems or audio players.

Many users find reusing headset that have been used before by other users to be unhygienic and are reluctant to use the distributed headsets. The problem with presently available distributed headsets is related to two issues. First, their cost is not negligible and therefore they are mostly reused to cut expenses. Second, even if these headsets are disposed, they are made from non-recyclable materials thus imposing a burden on the environment.

### SUMMARY OF THE INVENTION

The present invention is a disposable headset, wherein the standard components of the headphones (i.e., wire-guides, ear-members, etc.) are made from recyclable and disposable materials and further suggest a cheap and hygienic alternative for presently available distributed headsets.

According to embodiments of the present invention, the headset may comprise one or two ear-members and an oblong strip of isolating and disposable materials such as paper, cardboard and the like. The strip may be connected to an ear-member at each end. The ear-members and the connecting strip may be attached to at least parts of an audio system comprising of one or two speakers (respectively) connected by conductive-means to an audio player, where each speaker may be seated substantially at the central area of each car-member. According to embodiments of the invention, the conductive means may be electric copper wires, conductive ink, conductive glue etc.

Additionally, the connecting strip may comprise several joints that may allow adjusting the curve of the connecting strip to the curve line of a user's lower part of the face to facilitate the user in wearing the headset.

Additionally, the headset may further comprise of ear-fasteners connected to the ear-members that may facilitate the user in wearing the headset, where each ear-member may be connected to at least one ear-fastener.

According to embodiments of the present invention, the joints, the ear members, the connecting strip or at least parts of at least some of those components, may be made of recyclable isolating materials such as paper, carton and the like.

Additionally, the headset may be compacted as a kit where at least parts of the headset is folded enabling the user to build the headset by connecting and/or reshaping the compacted headset in order to create the final shape of the headset.

According to additional embodiments of the invention, the headset may further comprise a microphone holder and a microphone. The holder may be connected to the connecting strip and may be made from the same recyclable, disposable and isolating material as the strip and the microphone may be connected to the audio player by conductive means. The microphone holder may enable holding the microphone adjacent to the user's mouth, (‘Madonna’ Microphone) in a holding mechanism as known in the art.

The headset of this invention may be distributed by services providers to any users' types according to the providers' needs and wishes. For example, a flight company may freely distribute these headsets to its customers free of charge, where each customer may receive a new headset. The recyclable and isolating materials may allow substantially cheaper manufacturing costs and easier manufacturing speed to facilitate the provider in supplying each customer his/her own set.

Additionally, the headsets may be decorated and/or covered to advertise the provider or any other advertising source and/or according to fashion and the like.

Additionally or alternatively, the headset may be perfumed by perfuming materials dropped and soaked into the headsets' parts and/or cover said parts.

Additionally or alternatively, at least one accessory member may be attached to any part of the headset. For example, a rapped candy may be glued to the headset's connecting strip, a small pen, etc.

According to embodiments of the present invention, the ear-members, the fasteners and the connecting strip of each headset may be cut in the manufacturing process as a single piece, where the ear-fasteners may be folded later on to fasten the headset to the user's ear.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein:

FIG. 1 is a schematic illustration of headset, according to some embodiments of the invention;

FIG. 2 is a schematic illustration of a first isolating strip, according to some embodiments of the invention;

FIG. 3 is a schematic illustration of a second isolating strip, according to some embodiments of the invention;

FIG. 4 is a schematic illustration of attached first and second isolating strip, according to some embodiments of the invention;

FIG. 5 is a schematic illustration of attached first and second isolating strip with attached speakers, according to some embodiments of the invention.

FIG. 6 is a schematic illustration of a third isolation strip, according to some embodiments of the invention;

FIG. 7 is a schematic illustration of a connecting strip and of ear-members, according to some embodiments of the invention;

FIG. 8 is a schematic illustration of a connecting strip connected to ear-members, according to some embodiments of the invention;

FIG. 9 is a schematic illustration of headset with a microphone holder, according to additional embodiments of the invention; and

FIG. 10 schematically illustrates a connecting strip attached to joints, according to some embodiments of the present invention.

FIG. 11 is a schematic illustration of a headset with a single ear-member and a microphone set, according to some embodiments of the present invention.

FIG. 12 is a schematic illustration of a headset's disposable parts' mold, according to some embodiments of the present invention.

The drawings together with the description make apparent to those skilled in the art how the invention may be embodied in practice.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTIONS OF SOME EMBODIMENTS OF THE INVENTION

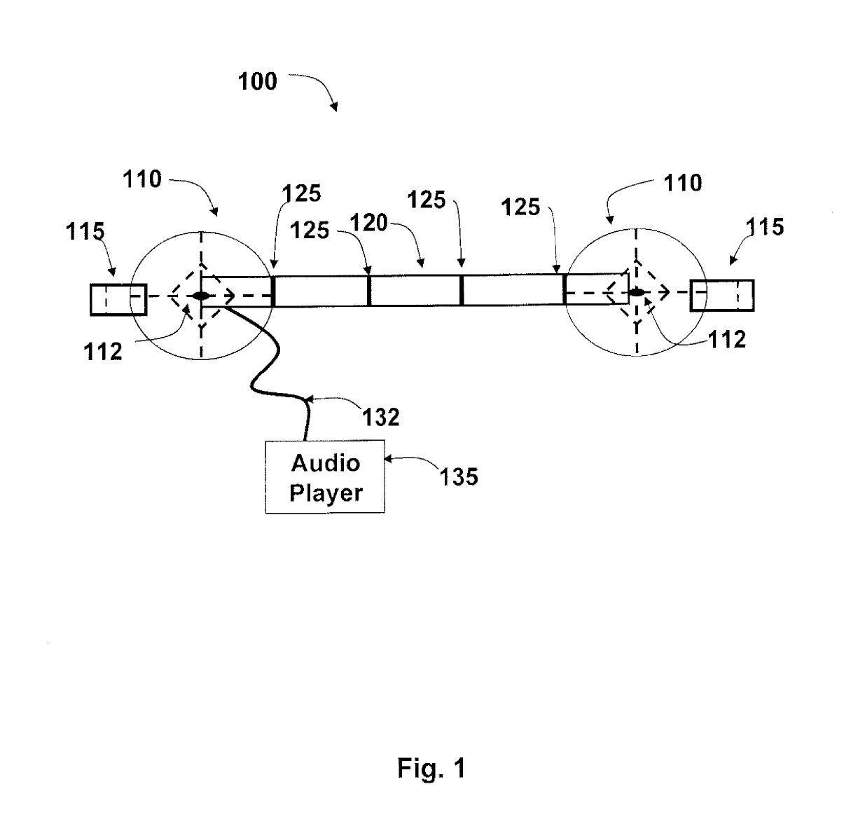

The present invention discloses a headset 110 that may comprise two ear-members 110 and a connecting strip 120 connecting the ear-members 110 at each end as illustrated in FIG. 1, according to some embodiments of the invention. At least parts of the ear-members 110 and the connecting strip 120 may be composed of recyclable isolating materials such as paper, paperboard, cardboard and the like. The ear members 110 and the connecting strip 120 may be connected to an audio player 135 by conductive-means 132 such as wires, conductive glue, conductive ink and the like.

Additionally, each ear-member 110 may be connected to at least one ear-fastener 115, as shown in FIG. 1. The ear-fasteners 115 may be designed to fasten the headset 100 on the user's ear-auricle, where the connecting strip 120 may be adjacent to the user's lower face (e.g., the user's chin) or to the top area of the user's head.

According to embodiments of the present invention, the ear-fasteners 115 may be of any shape and may be either folded part of the ear-member 110 or separated parts connected to the ear-members 110. The ear-fasteners 115 along with the ear-member 110 may be designed to enhance and improve the acoustics of the audio signals outputted from the speakers 131. For example the ear-member 110 may be concave shaped where its sunken side faces outwardly to capture the sound inside the ear-member 110. Alternatively, the ear-member 110 may be a substantially flat piece where the ear-fastener 115 is crescent to allow both fastening to the user's ear and improving acoustics.

Additionally, the connecting strip 120 may further comprise joints 125, as shown in FIG. 1 that may facilitate holding the connecting strip 120 in a specific shape. If, for example, the connecting strip 120 is substantially made of paper or cardboard, in order to enable keeping the shape of the user's lower face in a folded position, the joints 125 may be made from a more rigid material such as plastic or rope and additionally, clips may be used to join the folded parts of the strip 120.

According to embodiments of the present invention, the connecting strip 120 and the ear-members 110 may be made from disposable and substantially cheap materials such as paper or cardboard that may be recyclable as well, to facilitate and/or enable services providers such as flight or other transportation services, theaters or internet cards, for example, to distribute headsets 100 to their customers as advertising and promotion means or in order to improve hygiene, at lower costs. At least parts of the ear-members 110 and/or the connecting strip 120 may be decorated with advertising elements such as the company's logo, wearing instructions, or any other decorative and printable elements known in the art.

Additionally or alternatively, the headset 101) may be perfumed by perfuming materials that may be dropped and soaked into the headsets' parts (e.g. the connecting strip 120) and/or cover said parts.

Additionally or alternatively, at least one accessory may be attached to any part of the headset 100. For example, a rapped candy may be glued to the headset's connecting strip, a small pen, etc that may be glued to the connecting strip 120.

While the description below contains many specifications, these should not be construed as limitations on the scope of the invention, but rather as exemplification is of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

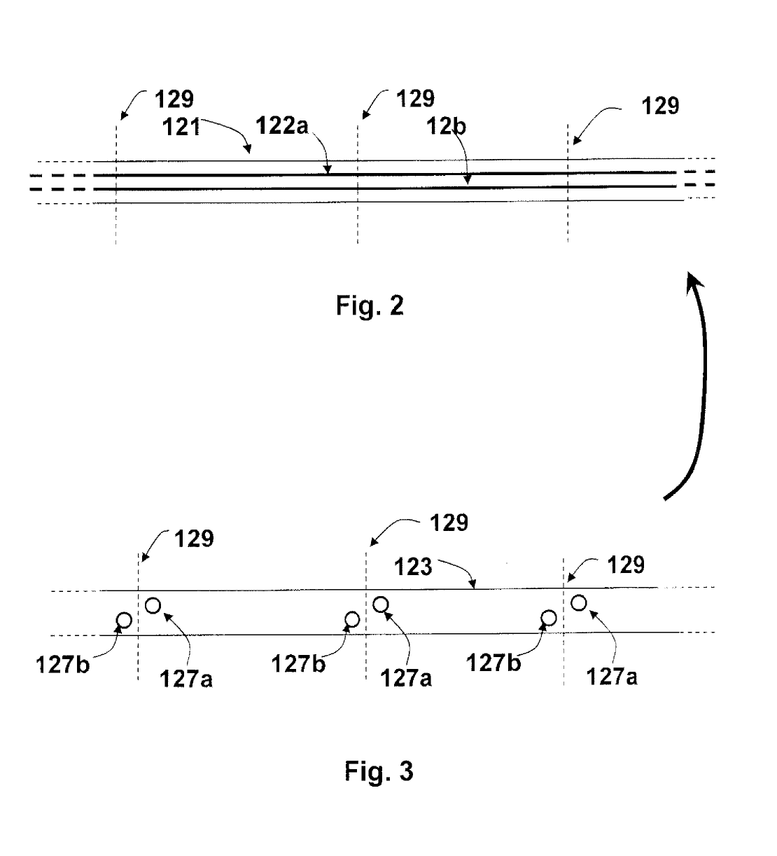

According to some embodiments of the present invention, to manufacture the connecting strip 120, a first strip 121 may be laid, as illustrated in FIG. 2 and attached to an upper conductive wire 122a and a lower conductive wire 122h, where the upper and lower conductive wires 122a and 122b may be substantially parallel. The strips 121 may be placed on an assembly line and cut at predefined cutting points or lines 129 according to a desired length of connecting strip 120.

The first strip 121 may be made of recyclable, disposable and isolating materials such as paper or cardboard, for example.

According to embodiments of the present invention, the upper and lower conductive wires 122a and 122b respectively, may be made of thin bare wires such as, for example, copper threads, lines of conductive glue or conductive ink and the like, to enable the headset 100 to be as light, as cheep and as recyclable as possible.

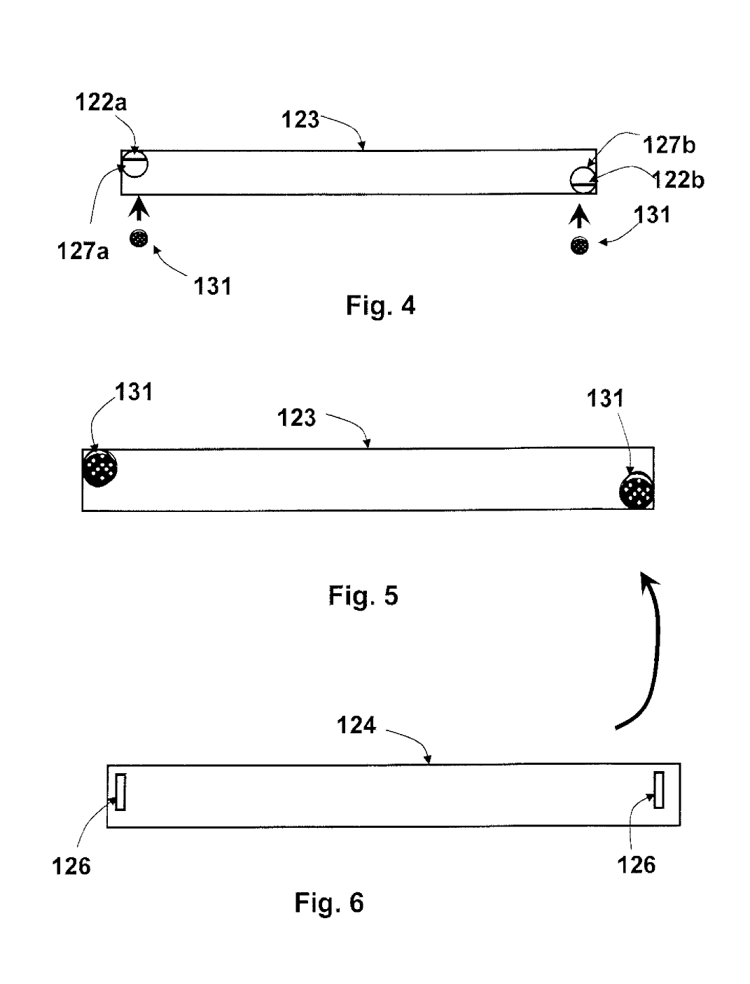

A second isolating strip 123 may be attached to the first isolating strip 121. The second strip 123 may be made of isolating recyclable and isolating materials such as paper or cardboard, for example. Additionally, the second strip 123 may comprise of an upper wire-opening 127a and a lower wire-opening 122b, as shown in FIG. 3. Once the second strip 123 is attached (e.g. glued) to the first strip 121—the upper wire-opening 127a may reveal part of the upper conductive wire 122a and the lower wire-opening 127b, may reveal part of the lower conductive wire 122b, as shown in FIG. 4.

According to embodiments of the invention, as illustrated in FIG. 4, each revealed conductive wire part 122a and 122b allows electric contact with the speakers 131 that may be placed on top of the wire-openings 127a and 127b, as shown in FIG. 5.

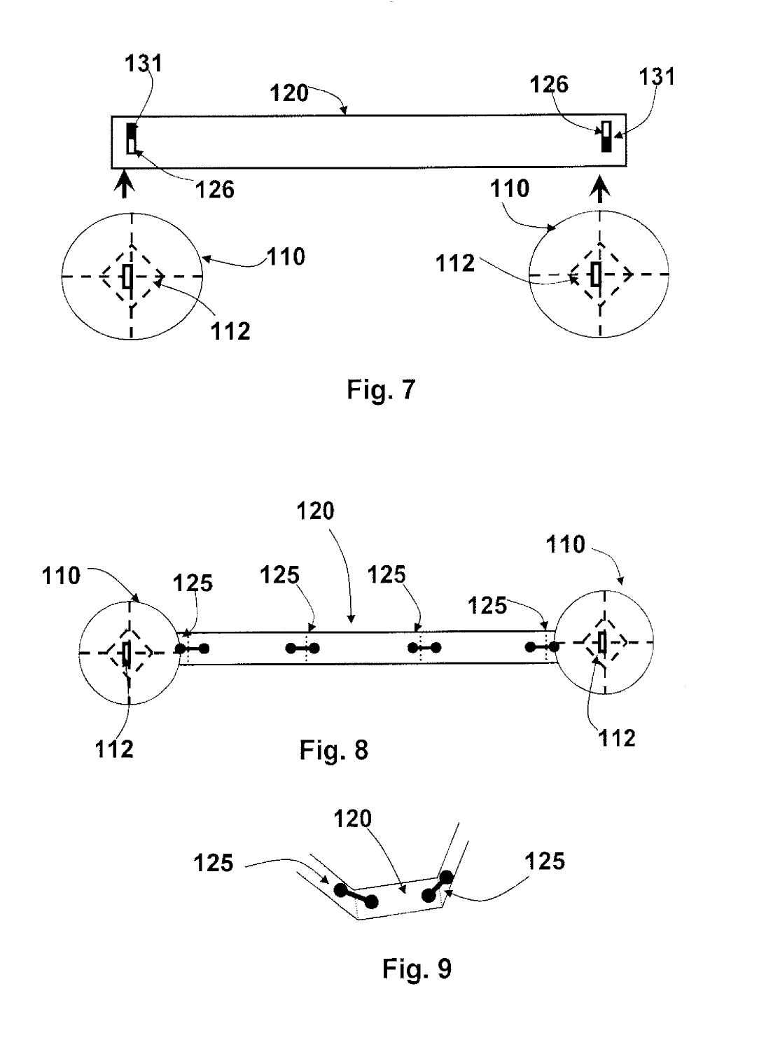

The second strip 123 may be adhesive at its upper part enabling farther attaching to a third strip 124. The third strip 124 that may comprise speaker-openings 126, as shown in FIG. 6, according to embodiments of the invention. The speaker openings 126 may be attached or glued to the already attached first and second strips 121 and 123 respectively. As illustrated in FIG. 7, according to embodiments of the invention, the speaker-openings 126 may enable revealing at least a part of the speakers' 131 surface to allow the sound vibrations to pass through. The ear-members 110 may too comprise openings 112 to avoid blocking of the sound coming out of the speakers 131, as shown in FIG. 7. The ear-members 110 may be attached to the edges of the connecting strip 120 substantially where the ear-members' openings 112 are on top of the speakers' openings 126, as illustrated in FIG. 8, where the connecting strip 120 may be the integrated attached first, second and third strips 121, 123 and 124 respectively.

According to some embodiments of the present invention, the connecting strip 120 may comprise pleats, where each pleat may be held by a joint 125. The joints 125 may be, for example, short rubber strings glued at their edges to the pleat sides substantially vertically to the pleat's line, as illustrated in FIG. 9. The joints 125 may facilitate in shaping the connecting strip 120 according to the user's wearing design.

According to some embodiments of the present invention, the user may wear the headset 100 device where the connecting strip 120 is placed adjacent to the lower part of the user's face meaning the chin area, where the ear-members 110 are fastened to the user's ears by the ear-fasteners 115.

According to embodiments of the present invention, the ear-fasteners 115 may be designed in any shape that allows fastening to the user's ear-auricle and may be connected to the ear-members 110 in any connecting means known in the art.

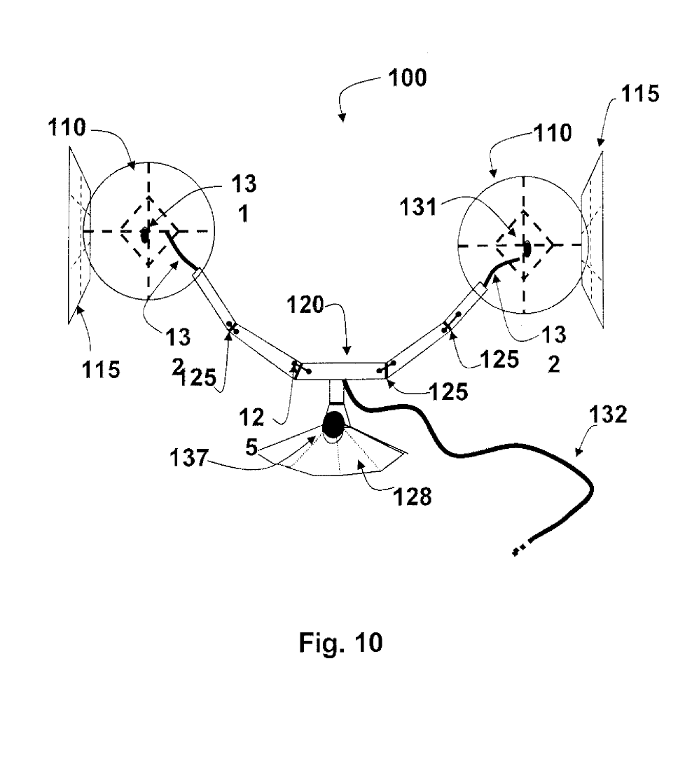

The headset 100 may additionally comprise a microphone holder 128 and a microphone 137, where the holder 128 may be connected to the connecting strip 120 and the microphone 137 may be connected to the audio player 135, as illustrated in FIG. 10, according to additional embodiments of the invention. The microphone holder 127 may be made from recyclable and disposable materials and may allow holding of the microphone 137 adjacent to the user's mouth.

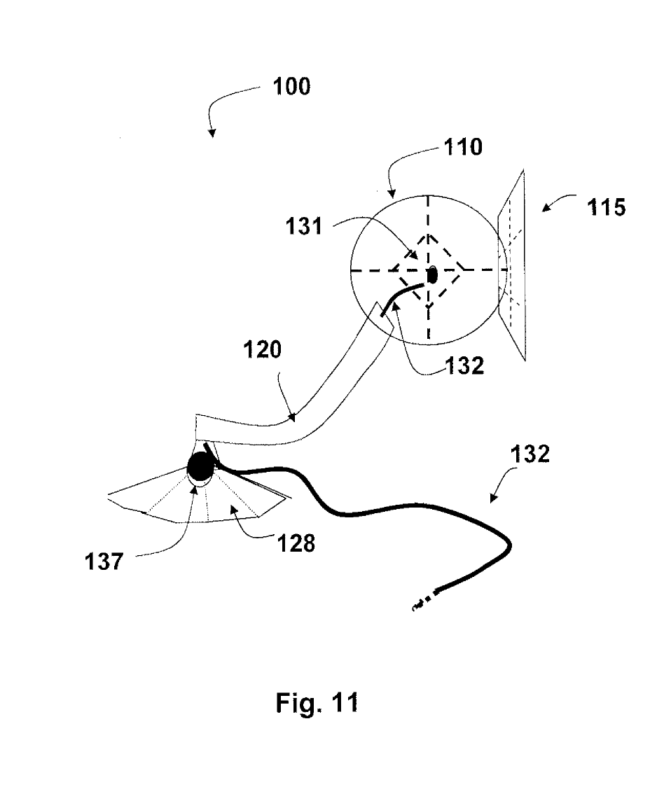

FIG. 11 schematically shows an embodiment of the headset 100 in which only one ear-member 110 is used, where the ear-member 110 connect to the microphone holder 127 is also the connecting strip 120.

According to some embodiments of the invention, the connecting strip 120 may be accordion-folded, as illustrated in FIG. 11, where the folds enable the user to adjust the length of the connecting strip 120 to the user's own comfort and size. The folds may be regarded as joints 125 that may also facilitate in substantially maintaining the shape of the connecting strip 120.

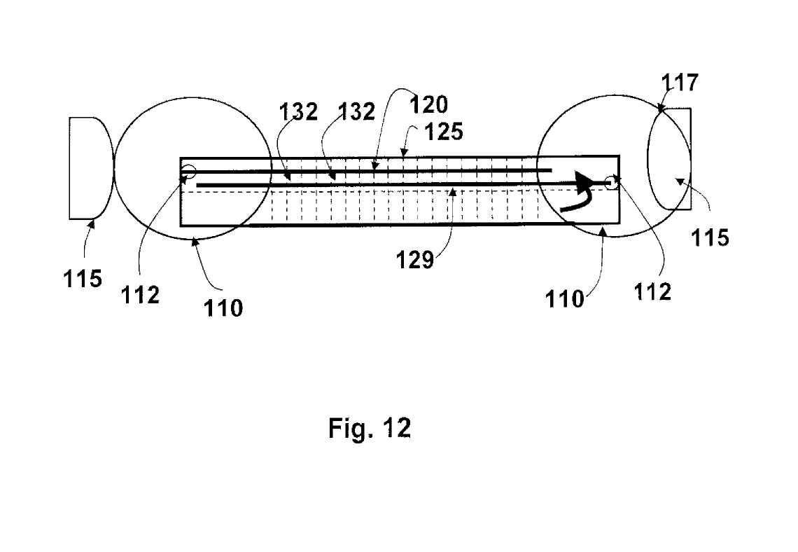

FIG. 12 schematically illustrates the headset's 100 disposable parts integrated into a single piece, to allow cutting single pieces out of a single mold in the manufacturing process. The ear-members 110, the car-fasteners 115 and the connecting strip 120 of each headset may be cut in the manufacturing process as a single piece, where the ear-fasteners 115 may be folded in the process to fasten the headset 100 to the user's ear. Each ear-fastener 115 may be ergonomically designed, for example, in a crescent shape where the crescent-shape can be folded inwardly towards the ear-member 110 creating a niche 117 between the ear-member 110 and the ear-fastener 115 where to fasten the ear-fastener 115 upon the user's ear-auricle—the user may slide the ear-member 110 upon the upper part of the ear auricle to insert the upper part of the auricle into the niche 117.

Additionally, the connecting strip 120 may include joints 125 as folding marks that may be used to accordion-fold the strip 120. The connecting strip 120 may be designed with an additional folding line 129 that may enable folding the strip 120 upon inserting conductive means 132 and connecting the internal folding parts by connecting means (e.g. glue), where the folding may enclose the conductive means inside the connecting strip 120.

Additionally, the conductive means 132 by which the speakers 131 are connected to the audio player 135 may be manufactured in a similar way as the connecting strip's 120 conductive means 132 where at least two isolating strips 121, 123 may be attached to each other holding a conductive thread (which may be the conductive means 132) between them. The conductive means 132 may be connected to one of the ear members 110 or the connecting strip 120 edge at one end and to the audio player 135 at the other end.

According to embodiments of the present invention, the headset 100 may be compacted as a kit where at least parts of the headset 100 may be folded enabling the user to unfold these parts and/or to build the headset 100 by connecting and shaping (e.g. by folding) in order to create the final shape of the headset 100.

For example, the kit may comprise the ear-members 110 connected to the connecting strip 120 and folded and packed separately from the audio player 135.

According to embodiments of the invention, the ear-members 110 and/or connecting strip 120 may be covered, painted, or printed by advertising elements. For example, if the headset 100 is purposed to be distributed to air-transportation passengers in flights the headset 100 paper parts may be printed with the flight company's logo. The users may be allowed to take the headset 100 once the flight is over as a souvenir that may serve the fight company as a marketing distribution tool.

According to embodiments of the invention, the conductive-means 132 conducting electric signals from the audio player 135 to the speakers 131 and/or from the microphone 137 to the audio player 135 may be any means known in the art that allow conductivity of electric signals such as, for example, electric copper wires, conductive ink, conductive glue etc.

Additionally, the connecting strip 120 may be accordion-folded to allow length adjustment to fit a multiplicity of users' head-sizes.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A headset comprising:
at least one ear-member integrated with at least one ear-fastener;
at least one speaker seated in said ear-member;
a connecting strip integrated with said ear-member, wherein said connecting strip is connectable to an audio player, and wherein said connecting strip comprises conductive means to allow transmission of electronic signals from the audio player to said speaker;
wherein said ear-fastener enables fastening said ear-member to a user's ear to fasten said headset to said user's head;
and wherein said ear-member, ear-fastener and connecting strip are made from recyclable and disposable materials.

2. The headset of claim 1 wherein said connecting strip further comprising of at least two joints that allow shaping of said connecting strip to adjust the curve of said connecting strip to the curve line of a user's lower part of the lace in order to facilitate in fastening said headset to said user's head.

3. The headset of claim 1 wherein said connecting strip comprises:
a first adhesive isolating strip; attached to
at least two substantially parallel conductive wires; and
a second adhesive isolating strip having at least two wire-openings,
wherein said second strip is attached to said first strip and wherein said wire-openings enable electrical connection between said wires and said speakers; and
a third adhesive isolating strip having speaker-openings to allow holding the speakers between the second and the third strips, wherein the speaker-openings align with the wire-openings.

4. The headset of claim 1 wherein each said ear-fastener is ergonomically shaped and folded inwardly towards the ear-member, creating a niche between said ear-member and said ear-fastener, where to fasten the ear-fastener upon the user's ear-auricle, the user is enabled to slide the ear-member upon the upper part of the ear-auricle to insert said upper part of the auricle into said niche.

5. The headset of claim 2 wherein said joints are made from recyclable materials and are connected to said connecting strip by fastening means.

6. The headset of claim 1 wherein said headset is compacted as a kit, wherein at least parts of the headset are folded enabling the user to build the headset by connecting and shaping said compacted headset in order to create the final shape of the headset.

7. The headset of claim 1 wherein said ear-member is shaped in a substantially concave shape to facilitate in enhancing the acoustic resonance of the sound signals coming out of the speakers.

8. The headset of claim 1 further comprising of a microphone holder and a microphone, wherein said holder is connected to the connecting strip and said microphone is connected to the audio player by conductive means wherein said microphone holder enables holding said microphone adjacent to the user's mouth.

9. The headset of claim 1 wherein at least parts of said connecting strip and ear members are decorated by advertising elements.

10. The headset of claim 1 wherein said conductive means that connect the speakers to the audio player are composed of at least one conductive thread covered by isolating recyclable and disposable materials.

11. The headset of claim 1, further comprising a perfume drop soaked into the isolating material.

12. The headset of claim 1, further comprising at least one accessory attached to the connecting strip.

13. The headset of claim 1 wherein said connecting strip is accordion-folded to allow length adjustment.

14. The headset of claim 1 wherein said ear-members, ear-fasteners and connecting strip are integrated into a single piece that is cut in the manufacturing process according to a single mold.

15. The headset of claim 14 wherein, the connecting strip includes
a multiplicity of folding marks to facilitate in accordion-folding the connecting strip and
a folding line to enable folding said connecting strip upon inserting conductive means between the internal parts of the folded strip, wherein said folding encloses the conductive means inside the connecting strip.

16. The headset of claim 15 wherein said conductive means that electronically connect the speakers to the audio player are copper-threads.

17. The headset of claim 15 wherein said conductive means that electronically connect the speakers to the audio player are lines of conductive glue.

18. The headset of claim 15 wherein said conductive means that electronically connect the speakers to the audio player are lines of conductive ink.
